(19) United States
(12) Patent Application Publication
(10) Pub. No.: US 2022/0333031 A1
(43) Pub. Date: Oct. 20, 2022

(54) FLUID DYNAMIC BEARING LUBRICATING OIL BASE OIL, FLUID DYNAMIC BEARING LUBRICATING OIL, FLUID DYNAMIC BEARING, MOTOR, AND FAN MOTOR

(71) Applicant: NIDEC CORPORATION, Kyoto (JP)

(72) Inventors: Meguru SUGIYAMA, Kyoto (JP); Akane KATO, Kyoto (JP); Akinobu TAKEGAMI, Kyoto (JP); Yuki KAWAHARA, Kyoto (JP); Naoko KASHIWA, Kyoto (JP)

(21) Appl. No.: 17/723,473

(22) Filed: Apr. 19, 2022

(30) Foreign Application Priority Data
Apr. 20, 2021 (JP) 2021-070747

(51) Int. Cl. C10M 105/42; F16C 33/10; F16C 33/66

(52) U.S. Cl. CPC C10M 105/42; F16C 33/109; F16C 33/6688; C10N 2040/02

(57) ABSTRACT

To provide a fluid dynamic bearing lubricating oil base oil which is within a suitable 40° C. and 100° C. kinematic viscosity range capable of achieving both energy saving and high bearing rigidity, and is excellent in viscosity index, heat resistance (evaporation resistance), and low temperature fluidity. Provided is a fluid dynamic bearing lubricating oil base oil containing an isophthalic acid diester compound represented by the following general formula (1)

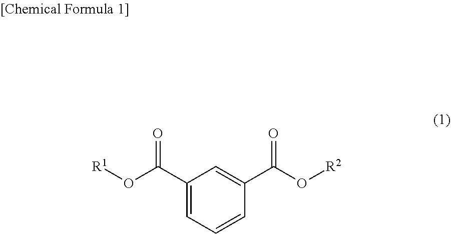

wherein R1 and R2 are the same or different and each represent a linear alkyl group having 6 to 10 carbon atoms.

### CROSS-REFERENCE TO RELATED APPLICATIONS

The present invention claims priority under 35 U.S.C. § 119 to Japanese Patent Application No. 2021-070747 filed on Apr. 20, 2021, the entire content of which is incorporated herein by reference.

### FIELD OF THE INVENTION

The present disclosure relates to a fluid dynamic bearing lubricating oil base oil, a fluid dynamic bearing lubricating oil, a fluid dynamic bearing, a motor, and a fan motor.

### BACKGROUND

A fluid dynamic bearing device has features such as high rotation accuracy and low noise. In a fluid dynamic bearing device, as a bearing device for a motor to be mounted on various electric devices including information devices that are strongly required to achieve high speed, small size, and long life, specifically, as a bearing device for a spindle motor incorporated in a disk drive device such as a hard disk drive, a fan motor incorporated in the disk drive device, a PC, or the like, or a polygon scanner motor incorporated in a laser beam printer, a fluid dynamic bearing has been put to practical use.

Recently, IT devices typified by laptop computers and the like have been continuously thinned. In addition to the thinning, a fluid dynamic bearing device used in a motor is also required to cope with the thinning. By reducing an axial dimension of a shaft member serving as a spindle of the fluid dynamic bearing device and a bearing sleeve supporting the shaft member, it is possible to cope with the thinning. However, when the axial dimension of the fluid dynamic bearing device is reduced, bearing rigidity is reduced as compared with the conventional motor. In addition, in order to further improve quietness, the frequency of use in a lower speed range is increased as compared with the conventional motor. In the fluid dynamic bearing, when the fluid dynamic bearing is driven in a low speed range, the fluid dynamic pressure is lower than when the fluid dynamic bearing is driven in a high speed range. That is, rotational rigidity further decreases. Thus, if the axial dimension of the bearing sleeve is shortened in order to cope with the thinning, it is difficult to obtain the bearing rigidity, and thus the axial dimension cannot be shortened in order to secure the bearing rigidity.

As described above, in order to secure the bearing rigidity, improvement of the bearing rigidity is also required for a fluid dynamic bearing oil base oil to be used. As a kinematic viscosity of the fluid dynamic bearing oil base oil is higher, the bearing rigidity of the fluid dynamic bearing is higher. However, as the kinematic viscosity is higher, viscous resistance of the fluid dynamic bearing increases, and energy loss increases, which is a problem.

A motor including a fluid dynamic bearing device is expected to be applied to an ECU (electronic control unit) mounted on a fifth generation mobile communication system (5G) communication device or an automobile, and a use environment temperature is increased. Therefore, a fluid dynamic bearing oil base oil for a motor to be used is required to have further heat resistance (evaporation resistance).

In recent years, there has been proposed a lubricating oil base oil for a fluid dynamic bearing using a synthetic hydrocarbon-based lubricating oil base oil such as poly-α-olefin, an ester-based lubricating oil base oil such as aliphatic dibasic acid diester, neopentyl-type polyol ester, or fatty acid monoester, or another oil, which strongly demands the size reduction, thinning, and further improvement of quietness of the fluid dynamic bearing and aims to increase the life.

Among them, ester-based lubricating oil base oils excellent in viscosity characteristics, low temperature fluidity, and the like are often used as the lubricating oil base oil for a fluid dynamic bearing. However, a fluid dynamic bearing lubricating oil base oil is required which is excellent in viscosity index, heat resistance (evaporation resistance), and low temperature fluidity, and satisfies all conditions that enable achievement of both energy saving and high bearing rigidity.

### SUMMARY

It has been found that a lubricating oil base oil mainly composed of an aromatic dicarboxylic acid diester compound having a specific structure and a 40° C. and 100° C. kinematic viscosity range is within a suitable 40° C. and 100° C. kinematic viscosity range which is excellent in viscosity index, heat resistance (evaporation resistance), and low temperature fluidity and is capable of achieving both energy saving and high bearing rigidity, and is compatible with a fluid dynamic bearing lubricating oil base oil, particularly, a fluid dynamic bearing lubricating oil base oil for a fan motor.

### [Item 1]

A fluid dynamic bearing lubricating oil base oil containing an isophthalic acid diester compound represented by the following general formula (1)

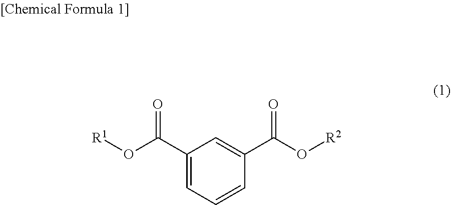

wherein R1 and R2 are the same or different and each represent a linear alkyl group having 6 to 10 carbon atoms.

### [Item 2]

The fluid dynamic bearing lubricating oil base oil according to [Item 1], wherein R1 and R2 represented by the general formula (1) are the same or different and each are a linear alkyl group having 7 to 10 carbon atoms.

### [Item 3]

The fluid dynamic bearing lubricating oil base oil according to [Item 1], wherein the isophthalic acid diester compound is di-n-octyl isophthalate or an ester mixture of (di-n-octyl isophthalate, di-n-decyl isophthalate, and isophthalate (n-decyl) (n-octyl)).

### [Item 4]

The fluid dynamic bearing lubricating oil base oil according to any one of [Item 1] to [Item 3], wherein a content of the isophthalic acid diester compound represented by the general formula (1) is 70% by mass or more in the fluid dynamic bearing lubricating oil base oil.

### [Item 5]

The fluid dynamic bearing lubricating oil base oil according to any one of [Item 1] to [Item 3], wherein a content of the isophthalic acid diester compound represented by the general formula (1) is 90% by mass or more in the fluid dynamic bearing lubricating oil base oil.

### [Item 6]

The fluid dynamic bearing lubricating oil base oil according to any one of [Item 1] to [Item 5], wherein a kinematic viscosity at 40° C. is 17 to 33 mm²/s.

### [Item 7]

The fluid dynamic bearing lubricating oil base oil according to any one of [Item 1] to [Item 6], wherein a pour point is −25° C. or less.

### [Item 8]

A fluid dynamic bearing lubricating oil base oil containing the fluid dynamic bearing lubricating oil base oil according to [Item 1] to [Item 7] being a fluid dynamic bearing lubricating oil base oil for a fan motor.

### [Item 9]

A fluid dynamic bearing lubricating oil containing the fluid dynamic bearing lubricating oil base oil according to any one of [Item 1] to [Item 7].

### [Item 10]

A fluid dynamic bearing lubricating oil containing the fluid dynamic bearing lubricating oil according to [Item 9] being a fluid dynamic bearing lubricating oil for a fan motor.

### [Item 11]

A fluid dynamic bearing lubricating oil containing the fluid dynamic bearing lubricating oil base oil according to any one of [Item 1] to [Item 8] and an antioxidant.

### [Item 12]

The fluid dynamic bearing lubricating oil according to [Item 11], wherein the antioxidant is a phenol-based antioxidant and/or an amine-based antioxidant.

### [Item 13]

A fluid dynamic bearing including the fluid dynamic bearing lubricating oil according to any one of [Item 9] to [Item 12].

### [Item 14]

A motor including the fluid dynamic bearing according to [Item 13].

### [Item 15]

A fan motor including the motor according to [Item 14].

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view of a fluid dynamic bearing;

FIG. 2 is a cross-sectional view of a sleeve;

FIG. 3 is a plan view of the sleeve;

FIG. 4 is a bottom view of the sleeve; and

FIG. 5 is a cross-sectional view near a bearing portion.

### DETAILED DESCRIPTION

An exemplary embodiment of the present disclosure will be described in detail with reference to the drawings. In this description, an upper side in a center axis direction of a motor is referred to as an “upper side”, and a lower side in the center axis direction of the motor is referred to as a “lower side”. The vertical direction does not indicate a positional relationship or a direction at the time of being incorporated in actual equipment. A direction parallel or substantially parallel to the center axis is referred to as an “axial direction (axial/axially)”, a radial direction about the center axis is referred to as a “radial direction (radial/radially)”, and a circumferential direction about the center axis is referred to as a “circumferential direction (circumferential/circumferentially)”.

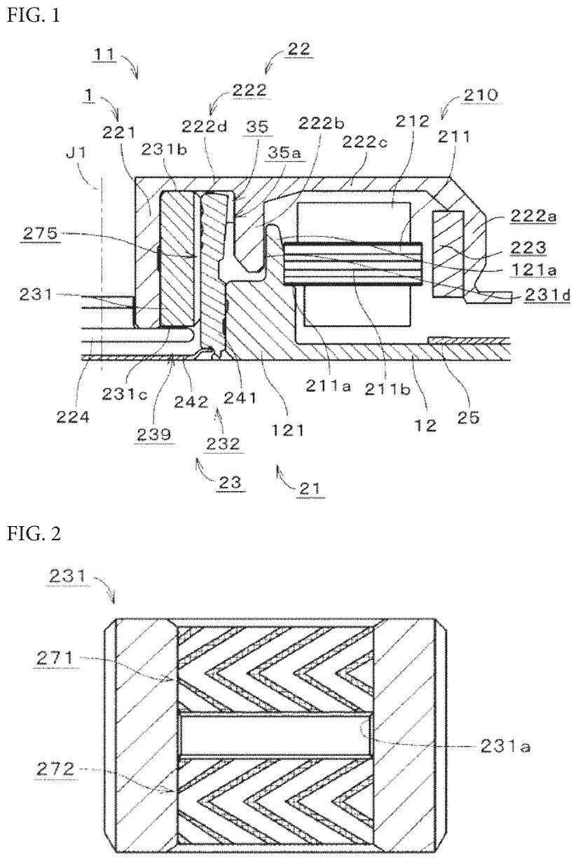

FIG. 1 is a cross-sectional view of a fluid dynamic bearing. A motor portion 11 includes a stationary unit 21 and a rotary unit 22. The stationary unit 21 has a bearing portion 23, a base portion 12, a stator 210, and a circuit board 25.

The bearing portion 23 is disposed radially inward of the stator 210. The bearing portion 23 includes a sleeve 231 and a bearing housing 232. The sleeve 231 has a substantially cylindrical shape centered on a central axis J1. The sleeve 231 is a metal sintered body. The sleeve 231 is impregnated with a lubricating oil. An outer peripheral surface of the sleeve 231 is provided with a plurality of circulation grooves 275 which extends in the axial direction and through which the lubricating oil circulates. The plurality of circulation grooves 275 are arranged at equal intervals in the circumferential direction. The bearing housing 232 has a bottomed substantially cylindrical shape, and includes a housing cylindrical portion 241 and a cap 242. The housing cylindrical portion 241 has a substantially cylindrical shape centered on the central axis J1 and covers the outer peripheral surface of the sleeve 231. The sleeve 231 is fixed to an inner peripheral surface of the housing cylindrical portion 241 with an adhesive. The bearing housing 232 is formed of metal. The cap 242 is fixed to a lower end of the housing cylindrical portion 241. The cap 242 closes a lower portion of the housing cylindrical portion 241. The sleeve 231 may be fixed with a material other than the adhesive, and may be fixed to the inner peripheral surface of the housing cylindrical portion 241 by press fitting, for example. The sleeve 231, the bearing housing 232, and the cap 242 may be formed from a material having excellent thermal conductivity other than metal. For example, they may be formed from a thermally conductive resin or brass.

The base portion 12 has a rising portion 121 radially inward. The rising portion 121 is a substantially annular member. A lower region of an outer peripheral surface of the housing cylindrical portion 241, that is, a lower region of an outer peripheral surface of the bearing housing 232 is fixed to an inner peripheral surface of the rising portion 121 by adhesion or press fitting. Both adhesion and press-fitting may be used for fixing the bearing housing 232 and the rising portion 121.

The stator 210 is a substantially annular member centered on the central axis J1. The stator 210 includes a stator core 211 and a plurality of coils 212 formed on the stator core 211. The stator core 211 is formed by stacking thin silicon steel sheets. The stator core 211 has a substantially annular core back 211a and a plurality of teeth 211b protruding radially outward from the core back 211a. The plurality of coils 212 are formed by winding a conductive wire around each of the plurality of teeth 211b. The circuit board 25 is disposed below the stator 210. The coil 212 has a leader wire that is electrically connected to the circuit board 25. The circuit board 25 is an FPC (Flexible Printed Circuitboard).

The rotary unit 22 includes a shaft 221, a thrust plate 224, a rotor hub 222, and a magnet 223. The shaft 221 is disposed about the central axis J1.

The rotor hub 222 has a substantially cylindrical shape with a lid centered on the central axis J1. The rotor hub 222 includes a magnet holding cylindrical portion 222a which is a cylindrical portion, a lid 222c, and a first thrust portion 222d. The magnet holding cylindrical portion 222a, the lid 222c, and the first thrust portion 222d are one continuous member. The first thrust portion 222d expands radially outward from an upper end portion of the shaft 221. The lid 222c expands radially outward from the first thrust portion 222d. A lower surface of the lid 222c is a substantially annular surface surrounding the shaft 221. The first thrust portion 222d axially faces an upper surface 231b of the sleeve 231 and an upper surface of the housing cylindrical portion 241.

The thrust plate 224 has a substantially disk-shaped portion expanding radially outward. The thrust plate 224 is fixed to a lower end of the shaft 221 and extends radially outward from the lower end. The thrust plate 224 is accommodated in a plate accommodating portion 239 constituted of a lower surface 231c of the sleeve 231, an upper surface of the cap 242, and a lower portion of the inner peripheral surface of the housing cylindrical portion 241. An upper surface of the thrust plate 224 is a substantially annular surface surrounding the shaft 221. The upper surface of the thrust plate 224 axially faces the lower surface 231c of the sleeve 231, that is, a surface facing downward in the plate accommodating portion 239. Hereinafter, the thrust plate 224 is referred to as the “second thrust portion 224”. A lower surface of the second thrust portion 224 faces the upper surface of the cap 242 of the bearing housing 232. The shaft 221 is inserted into the sleeve 231. The thrust plate 224 may be configured as a member connected to the shaft 221. The thrust plate 224 is formed of a metal such as stainless steel, for example.

The shaft 221 is configured as a member connected to the rotor hub 222. The shaft 221 and the rotor hub 222 are formed by cutting a metal member. That is, the lid 222c and the shaft 221 are continuous. The shaft 221 may be configured of a member separately from the rotor hub 222. In this case, the upper end of the shaft 221 is fixed to the lid 222c of the rotor hub 222. The magnet 223 is fixed to an inner peripheral surface of the magnet holding cylindrical portion 222a extending axially downward from a radially outer end of the lid 222c of the rotor hub 222, and the magnet 223 is disposed on a radially outer side of the stator 210. The shaft 221 is formed of a metal such as stainless steel, for example.

The rotor hub 222 further includes a substantially annular cylindrical portion 222b extending downward from an outer edge of the first thrust portion 222d. Hereinafter, the annular cylindrical portion 222b is referred to as the “rotor hub cylindrical portion 222b”. In the rotor hub 222, the rotor hub cylindrical portion 222b is located radially inside the stator 210. The rotor hub cylindrical portion 222b is located radially outside the bearing housing 232, and the inner peripheral surface of the rotor hub cylindrical portion 222b radially faces an outer peripheral surface of an upper portion of the housing cylindrical portion 241. A seal gap 35 is formed between the inner peripheral surface of the rotor hub cylindrical portion 222b and the outer peripheral surface of the housing cylindrical portion 241. A seal portion 35a where an interface of lubricating oil is located is formed in the seal gap 35.

The rising portion 121 has a rising upper cylindrical portion 121a extending upward from the upper end. An outer peripheral surface of the rotor cylindrical portion 222b rises through a radial gap (hereinafter, referred to as a minute gap 231d) and faces an inner peripheral surface of an upper cylindrical portion 121a. As a result, ingress and egress of gas in the minute gap 231d are suppressed. As a result, evaporation of the lubricating oil from the seal portion 35a is suppressed. A radial width of the minute gap 231d is 0.15 mm or smaller than 0.15 mm. More preferably, the radial width of the minute gap 231d is 0.10 mm or smaller than 0.10 mm.

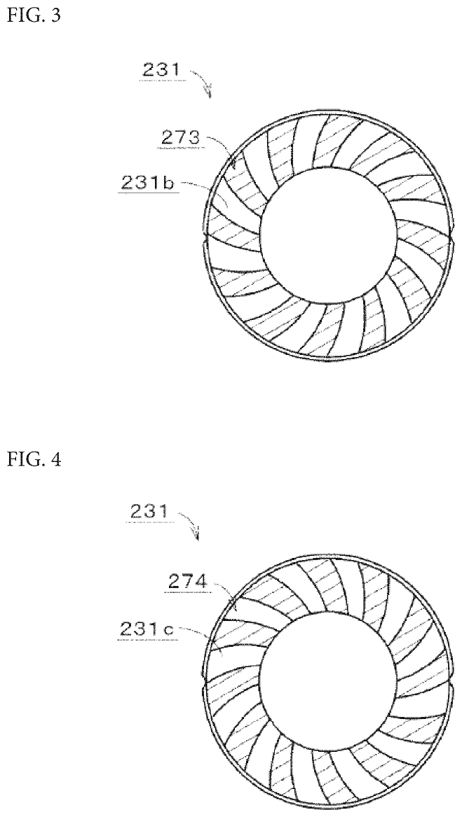

FIG. 2 is a cross-sectional view of the sleeve 231. A first radial dynamic pressure groove array 271 and a second radial dynamic pressure groove array 272 configured by a plurality of herringbone-shaped grooves are provided in an upper portion and a lower portion of the inner peripheral surface 231a of the sleeve 231. FIG. 3 is a plan view of the sleeve 231. A first thrust dynamic pressure groove array 273 configured by a plurality of spiral grooves is provided on the upper surface 231b of the sleeve 231. FIG. 4 is a bottom view of the sleeve 231. A second thrust dynamic pressure groove array 274 having a spiral shape is provided on the lower surface 231c of the sleeve 231.

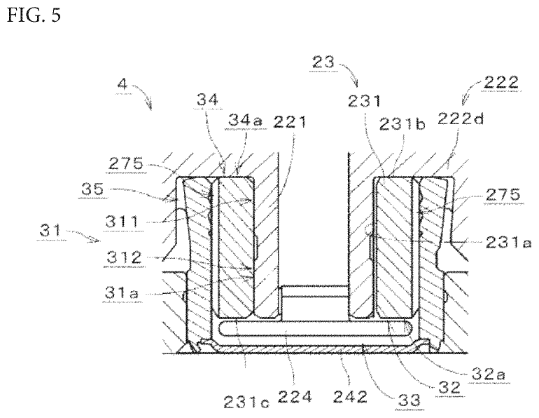

FIG. 5 is a cross-sectional view near the bearing portion 23. A radial gap 31 is formed between an outer peripheral surface of the shaft 221 and the inner peripheral surface 231a of the sleeve 231. The radial gap 31 has a first radial gap 311 and a second radial gap 312 located below the first radial gap 311. The first radial gap 311 is formed between the outer peripheral surface of the shaft 221 and a portion of the inner peripheral surface 231a of the sleeve 231 where the first radial dynamic pressure groove array 271 of FIG. 2 is provided. A lubricating oil is interposed in the first radial gap 311. The second radial gap 312 is formed between the outer peripheral surface of the shaft 221 and a portion of the inner peripheral surface 231a of the sleeve 231 where the second radial dynamic pressure groove array 272 of FIG. 2 is provided. A lubricating oil is interposed in the second radial gap 312. The first radial gap 311 and the second radial gap 312 constitute a radial dynamic pressure bearing portion 31a that generates a fluid dynamic pressure of the lubricating oil. The shaft 221 is supported in the radial direction by the radial dynamic pressure bearing portion 31a. The radial width of the radial gap 31 is 5 μm or smaller than 5 μm. More preferably, the radial width of the radial gap 31 is 3 μm or smaller than 3 μm.

The thrust portion (not shown) includes the first thrust portion 222d which is an upper thrust portion and the second thrust portion 224 which is a lower thrust portion. A first thrust gap 34 is formed between a portion of the upper surface 231b of the sleeve 231 where the first thrust dynamic pressure groove array 273 is provided and a lower surface of the first thrust portion 222d. A lubricating oil is interposed in the first thrust gap 34. The first thrust gap 34 constitutes an upper thrust dynamic pressure bearing portion 34a that generates a fluid dynamic pressure in the lubricating oil. The first thrust portion 222d is supported in the axial direction by the upper thrust dynamic pressure bearing portion 34a. The axial width of the first thrust gap 34 is 70 μm or smaller than 70 μm. More preferably, the axial width of the first thrust gap 34 is 45 μm or smaller than 45 μm.

A second thrust gap 32 is formed between a portion of the lower surface 231c of the sleeve 231 where the second thrust dynamic pressure groove array 274 is provided and the upper surface of the second thrust portion 224. A lubricating oil is interposed in the second thrust gap 32. The second thrust gap 32 constitutes a lower thrust dynamic pressure bearing portion 32a that generates the fluid dynamic pressure of the lubricating oil. The second thrust portion 224 is supported in the axial direction by the lower thrust dynamic pressure bearing portion 32a. The upper thrust dynamic pressure bearing portion 34a and the lower thrust dynamic pressure bearing portion 32a communicate with each other by the circulation groove 275.

A third thrust gap 33 is formed between the upper surface of the cap 242 of the bearing housing 232 and the lower surface of the second thrust portion 224. The third thrust gap 33 may generate a fluid dynamic pressure in the lubricating oil located between the upper surface of the cap 242 and the lower surface of the second thrust portion 224.

The motor portion 11 has a single bag structure in which the seal gap 35, the first thrust gap 34, the radial gap 31, the second thrust gap 32, and the third thrust gap 33 are connected to each other, and lubricating oil is continuously present in the bag structure. In the bag structure, the interface of the lubricating oil is formed only in the seal gap 35.

In the motor portion 11, the shaft 221, the first thrust portion 222d, the rotor hub cylindrical portion 222b extending downward from the outer edge of the first thrust portion 222d, the second thrust portion 224, the bearing portion 23, the rising portion 121, and the lubricating oil shown in FIG. 1 constitute a bearing mechanism 1 as a bearing device. Hereinafter, the shaft 221, the first thrust portion 222d, the rotor hub cylindrical portion 222b, the second thrust portion 224, the bearing portion 23, and the rising portion 121 will be described as a part of the bearing mechanism 1. In the bearing mechanism 1, the shaft 221, the first thrust portion 222d, and the second thrust portion 224 rotate relative to the bearing portion 23 via the lubricating oil.

The fluid dynamic bearing lubricating oil base oil of the present disclosure is characterized by containing a compound represented by the following general formula (1).

A compound according to the present disclosure is an isophthalic acid diester compound represented by the following general formula (1)

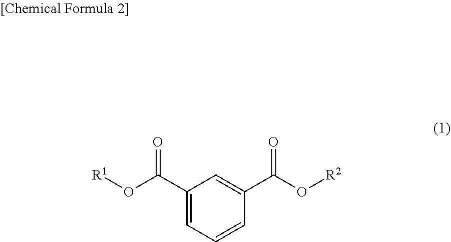

wherein R1 and R2 are the same or different and each represent a linear alkyl group having 6 to 10 carbon atoms.

In the isophthalic acid diester compound represented by the general formula (1), R1 and R2 are the same or different and are each particularly preferably a linear alkyl group having 7 to 10 carbon atoms.

In the compound represented by the general formula (1), when R1 and R2 are the same or different and are each a linear alkyl group having 1 to 5 carbon atoms, it is not preferable since kinematic viscosities at 40° C. and 100° C. of the fluid dynamic bearing lubricating oil base oil decrease, bearing rigidity decreases, and heat resistance (evaporation resistance) further deteriorates.

When R1 and R2 are the same or different and are each a linear alkyl group having 11 or more carbon atoms, the kinematic viscosities at 40° C. and 100° C. of the fluid dynamic bearing lubricating oil base oil increase, energy loss of a motor increases, and in addition, low temperature fluidity deteriorates, which is not preferable.

In the isophthalic acid diester compound represented by the general formula (1), when R1 and R2 are the same or different and are each a branched alkyl group, as compared with a linear alkyl group having the same carbon number, the kinematic viscosities at 40° C. and 100° C. of the fluid dynamic bearing lubricating oil base oil increases, and in addition, the viscosity index and the heat resistance (evaporation resistance) deteriorate, which is not preferable.

The isophthalic acid diester compound according to the present disclosure is not particularly limited by its production method as long as it satisfies performance as a lubricating oil base oil, and can be easily obtained by, for example, adding isophthalic acid or isophthalic acid dichloride and one or more linear alcohols having 6 to 10 carbon atoms to perform an esterification reaction. In addition, depending on the type of the linear alcohol, there is also a method in which isophthalic acid and a lower alcohol having about 1 to 4 carbon atoms are esterified in advance, and then one or more types of the linear alcohols are added to obtain the compound by transesterification reaction. From the viewpoint of convenience and practicality, a method is most preferable in which isophthalic acid and one or more types of the linear alcohols are added to obtain the compound by the esterification reaction.

In the isophthalic acid diester compound represented by the general formula (1), a mixed group ester in which R1 and R2 are different from each other is not particularly limited by its production method as long as it satisfies the performance as the lubricating oil base oil, and, for example, the mixed group ester can be obtained as a component contained in an ester mixture obtained by an esterification reaction of isophthalic acid and two to five types of alcohols selected from linear alcohols having 6 to 10 carbon atoms. From the viewpoint of practicality such as convenience, preferred is an ester mixture obtained by performing the esterification reaction using isophthalic acid and two alcohols selected from linear alcohols having 6 to 10 carbon atoms at a molar ratio of the two alcohols of 1:10 to 10:1, more preferred is an ester mixture obtained at a molar ratio of the two alcohols of 1:5 to 5:1, and still more preferred is an ester mixture obtained at a molar ratio of the two alcohols of 1:3 to 3:1.

In addition, the isophthalic acid diester compound may be separated or removed from the resulting ester mixture by a method such as distillation. For example, the low-boiling point and/or high-boiling point isophthalic acid diester compound in the resulting ester mixture may be removed by distillation, or only the mixed group ester in which R1 and R2 are different from each other may be separated.

Specific examples of the linear alcohol having 6 to 10 carbon atoms include 1-hexanol, 1-heptanol, 1-octanol, 1-nonanol, and 1-decanol. Among them, 1-heptanol, 1-octanol, 1-nonanol, and 1-decanol are particularly preferable.

Specific examples of the compound represented by the general formula (1) include di-n-hexyl isophthalate, di-n-heptyl isophthalate, di-n-octyl isophthalate, di-n-nonyl isophthalate, di-n-decyl isophthalate, isophthalic acid (n-hexyl) (n-heptyl), isophthalic acid (n-hexyl) (n-octyl), isophthalic acid (n-hexyl) (n-nonyl), isophthalic acid (n-decyl) (n-hexyl), isophthalic acid (n-heptyl) (n-octyl), isophthalic acid (n-heptyl) (n-nonyl), isophthalic acid (n-decyl) (n-heptyl), isophthalic acid (n-nonyl) (n-octyl), isophthalic acid (n-decyl) (n-octyl), isophthalic acid (n-decyl) (n-nonyl), an isophthalic acid diester mixture obtained by the esterification reaction of isophthalic acid with n-hexanol and n-heptanol (here, the isophthalic acid diester mixture obtained by the esterification reaction of isophthalic acid with n-hexanol and n-heptanol refers to an isophthalic acid diester mixture containing di-n-hexyl isophthalate, di-n-heptyl isophthalate, and isophthalic acid (n-hexyl) (n-heptyl), and hereinafter they have the same meaning), an isophthalic acid diester mixture obtained by the esterification reaction of isophthalic acid with n-hexanol and n-octanol, an isophthalic acid diester mixture obtained by the esterification reaction of isophthalic acid with n-hexanol and n-nonanol, an isophthalic acid diester mixture obtained by the esterification reaction of isophthalic acid with n-hexanol and n-decanol, an isophthalic acid diester mixture obtained by the esterification reaction of isophthalic acid with n-heptanol and n-octanol, an isophthalic acid diester mixture obtained by the esterification reaction of isophthalic acid with n-heptanol and n-nonanol, an isophthalic acid diester mixture obtained by the esterification reaction of isophthalic acid with n-heptanol and n-decanol, an isophthalic acid diester mixture obtained by the esterification reaction of isophthalic acid with n-octanol and n-nonanol, an isophthalic acid diester mixture obtained by the esterification reaction of isophthalic acid with n-octanol and n-decanol, an isophthalic acid diester mixture obtained by the esterification reaction of isophthalic acid with n-nonanol and n-decanol, an isophthalic acid diester mixture obtained by the esterification reaction of isophthalic acid with n-hexanol, n-heptanol and n-octanol, an isophthalic acid diester mixture obtained by the esterification reaction of isophthalic acid with n-hexanol, n-heptanol, and n-nonanol, an isophthalic acid diester mixture obtained by the esterification reaction of isophthalic acid with n-hexanol, n-heptanol, and n-decanol, an isophthalic acid diester mixture obtained by the esterification reaction of isophthalic acid with n-hexanol, n-octanol, and n-nonanol, an isophthalic acid diester mixture obtained by the esterification reaction of isophthalic acid with n-hexanol, n-octanol, and n-decanol, an isophthalic acid diester mixture obtained by the esterification reaction of isophthalic acid with n-hexanol, n-nonanol, and n-decanol, an isophthalic acid diester mixture obtained by the esterification reaction of isophthalic acid with n-heptanol, n-octanol, and n-nonanol, an isophthalic acid diester mixture obtained by the esterification reaction of isophthalic acid with n-heptanol, n-octanol, and n-decanol, an isophthalic acid diester mixture obtained by the esterification reaction of isophthalic acid with n-heptanol, n-nonanol, and n-decanol, an isophthalic acid diester mixture obtained by the esterification reaction of isophthalic acid with n-octanol, n-nonanol, and n-decanol, an isophthalic acid diester mixture obtained by the esterification reaction of isophthalic acid with n-hexanol, n-octanol, and n-decanol, an isophthalic acid diester mixture obtained by the esterification reaction of isophthalic acid with n-hexanol, n-heptanol, n-octanol, and n-nonanol, an isophthalic acid diester mixture obtained by the esterification reaction of isophthalic acid with n-hexanol, n-heptanol, n-octanol, and n-decanol, an isophthalic acid diester mixture obtained by the esterification reaction of isophthalic acid with n-hexanol, n-heptanol, n-nonanol, and n-decanol, an isophthalic acid diester mixture obtained by the esterification reaction of isophthalic acid with n-hexanol, n-octanol, n-nonanol, and n-decanol, an isophthalic acid diester mixture obtained by the esterification reaction of isophthalic acid with n-heptanol, n-octanol, n-nonanol, and n-decanol, and an isophthalic acid diester mixture obtained by the esterification reaction of isophthalic acid with n-hexanol, n-heptanol, n-octanol, n-nonanol, and n-decanol. Among them, di-n-heptyl isophthalate, di-n-octyl isophthalate, di-n-nonyl isophthalate, isophthalic acid (n-nonyl) (n-octyl), isophthalic acid (n-decyl) (n-octyl), isophthalic acid (n-decyl) (n-nonyl), an isophthalic acid diester mixture obtained by the esterification reaction of isophthalic acid with n-octanol and n-nonanol, an isophthalic acid diester mixture obtained by the esterification reaction of isophthalic acid with n-octanol and n-decanol, and an isophthalic acid diester mixture obtained by the esterification reaction of isophthalic acid with n-nonanol and n-decanol are preferable, and in particular, di-n-octyl isophthalate, isophthalic acid (n-decyl) (n-octyl), and an isophthalic acid diester mixture obtained by the esterification reaction of isophthalic acid with n-octanol and n-nonanol are preferable.

The isophthalic acid diester compound or two or more kinds of the isophthalic acid diester mixtures are mixed, and the mixture can be used as a fluid dynamic bearing lubricating oil base oil.

In the fluid dynamic bearing lubricating oil base oil, the content of the isophthalic acid diester compound represented by the general formula (1) is preferably 70% by mass or more, more preferably 90% by mass or more, and particularly preferably 98% by mass or more.

The bearing rigidity of the fluid dynamic bearing can be evaluated by the kinematic viscosities at 40° C. and 100° C. of the fluid dynamic bearing lubricating oil base oil, and the higher the kinematic viscosities at 40° C. and 100° C., the higher the bearing rigidity of the fluid dynamic bearing. However, if the kinematic viscosities at 40° C. and 100° C. are too high, the bearing rigidity increases; however, the viscous resistance of the fluid dynamic pressure bearing increases and the energy loss increases, which is not preferable. Thus, the 40° C. kinematic viscosity of the fluid dynamic bearing lubricating oil base oil is preferably 17 mm²/s or more and less than 33 mm²/s, and particularly preferably 20 mm²/s or more and less than 30 mm²/s. The 100° C. kinematic viscosity is preferably 3.5 mm²/s or more and less than 6.0 mm²/s, and particularly preferably 4.0 mm²/s or more and less than 5.0 mm²/s. When the 40° C. kinematic viscosity is 17 mm²/s or more, rigidity of a fluid lubrication film is good, and when the kinematic viscosity is less than 33 mm²/s, the energy loss is small. When the 100° C. kinematic viscosity is 3.5 mm²/s or more, the rigidity of the fluid lubrication film is good, and when the kinematic viscosity is less than 6.0 mm²/s, the energy loss is small. The kinematic viscosity is a value obtained by a method described in Examples below.

The viscosity index of the fluid dynamic bearing lubricating oil base oil is preferably 85 or more, and particularly preferably 95 or more. The higher the viscosity index, the better the viscosity-temperature characteristics. The viscosity index is a value obtained by a method described in Examples below.

The heat resistance of the fluid dynamic bearing lubricating oil base oil can be evaluated by evaporation resistance, and the evaporation resistance can be evaluated by using, for example, a temperature when a 5% mass of the fluid dynamic bearing lubricating oil base oil is reduced while using a TGDTA apparatus as an index. The 5% mass loss temperature of the fluid dynamic bearing lubricating oil base oil is preferably 240° C. or more, and particularly preferably 250° C. or more. The higher the 5% mass loss temperature, the better the evaporation resistance. The 5% mass loss temperature is a value obtained in an evaporation resistance test described in Examples below.

The low temperature fluidity of the fluid dynamic bearing lubricating oil base oil can be evaluated, for example, by a pour point. The pour point of the fluid dynamic bearing lubricating oil base oil is preferably −25° C. or less, and particularly preferably −40° C. or less. The lower the pour point, the better the low temperature fluidity. The pour point is a value obtained by a method described in Examples below.

Examples of the fluid dynamic bearing lubricating oil base oil include a fluid bearing oil base oil for a fan motor having a kinematic viscosity at 40° C. of 20 mm²/s or more and less than 30 mm²/s, a kinematic viscosity at 100° C. of 4.0 mm²/s or more and less than 5.0 mm²/s, a viscosity index of 95 or more, a 5% mass loss temperature of 240° C. or more, and a pour point of −25° C. or less, a fluid dynamic bearing lubricating oil base oil having a kinematic viscosity at 40° C. of 20 mm²/s or more and less than 30 mm²/s, a kinematic viscosity at 100° C. of 4.0 mm²/s or more and less than 5.0 mm²/s, a viscosity index of 85 or more, a 5% mass loss temperature of 250° C. or more, and a pour point of −25° C. or less, a fluid dynamic bearing lubricating oil base oil having a kinematic viscosity at 40° C. of 20 mm²/s or more and less than 30 mm²/s, a kinematic viscosity at 100° C. of 3.5 mm²/s or more and less than 6.0 mm²/s, a viscosity index of 95 or more, a 5% mass loss temperature of 250° C. or more, and a pour point of −25° C. or less, a fluid dynamic bearing lubricating oil base oil having a kinematic viscosity at 40° C. of 20 mm²/s or more and less than 30 mm²/s, a kinematic viscosity at 100° C. of 4.0 mm²/s or more and less than 5.0 mm²/s, a viscosity index of 85 or more, a 5% mass loss temperature of 240° C. or more, and a pour point of −40° C. or less, a fluid dynamic bearing lubricating oil base oil having a kinematic viscosity at 40° C. of 20 mm²/s or more and less than 30 mm²/s, a kinematic viscosity at 100° C. of 3.5 mm²/s or more and less than 6.0 mm²/s, a viscosity index of 95 or more, a 5% mass loss temperature of 240° C. or more, and a pour point of −40° C. or less, a fluid dynamic bearing lubricating oil base oil having a kinematic viscosity at 40° C. of 20 mm²/s or more and less than 30 mm²/s, a kinematic viscosity at 100° C. of 3.5 mm²/s or more and less than 6.0 mm²/s, a viscosity index of 85 or more, a 5% mass loss temperature of 250° C. or more, and a pour point of −40° C. or less, a fluid dynamic bearing lubricating oil base oil having a kinematic viscosity at 40° C. of 17 mm²/s or more and less than 33 mm²/s, a kinematic viscosity at 100° C. of 4.0 mm²/s or more and less than 5.0 mm²/s, a viscosity index of 95 or more, a 5% mass loss temperature of 250° C. or more, and a pour point of −25° C. or less, a fluid dynamic bearing lubricating oil base oil having a kinematic viscosity at 40° C. of 17 mm²/s or more and less than 33 mm²/s, a kinematic viscosity at 100° C. of 4.0 mm²/s or more and less than 5.0 mm²/s, a viscosity index of 95 or more, a 5% mass loss temperature of 240° C. or more, and a pour point of −40° C. or less, a fluid dynamic bearing lubricating oil base oil having a kinematic viscosity at 40° C. of 17 mm²/s or more and less than 33 mm²/s, a kinematic viscosity at 100° C. of 4.0 mm²/s or more and less than 5.0 mm²/s, a viscosity index of 85 or more, a 5% mass loss temperature of 250° C. or more, and a pour point of −40° C. or less, and a fluid dynamic bearing lubricating oil base oil having a kinematic viscosity at 40° C. of 17 mm²/s or more and less than 33 mm²/s, a kinematic viscosity at 100° C. of 3.5 mm²/s or more and less than 6.0 mm²/s, a viscosity index of 95 or more, a 5% mass loss temperature of 250° C. or more, and a pour point of −40° C. or less. A fluid dynamic bearing lubricating oil base oil having a kinematic viscosity at 40° C. of 20 mm²/s or more and less than 30 mm²/s, a kinematic viscosity at 100° C. of 4.0 mm²/s or more and less than 5.0 mm²/s, a viscosity index of 95 or more, a 5% mass loss temperature of 250° C. or more, and a pour point of −25° C. or less, a fluid dynamic bearing lubricating oil base oil having a kinematic viscosity at 40° C. of 20 mm²/s or more and less than 30 mm²/s, a kinematic viscosity at 100° C. of 4.0 mm²/s or more and less than 5.0 mm²/s, a viscosity index of 95 or more, a 5% mass loss temperature of 240° C. or more, and a pour point of −40° C. or less, a fluid dynamic bearing lubricating oil base oil having a kinematic viscosity at 40° C. of 20 mm²/s or more and less than 30 mm²/s, a kinematic viscosity at 100° C. of 4.0 mm²/s or more and less than 5.0 mm²/s, a viscosity index of 85 or more, a 5% mass loss temperature of 250° C. or more, and a pour point of −40° C. or less, a fluid dynamic bearing lubricating oil base oil having a kinematic viscosity at 40° C. of 20 mm²/s or more and less than 30 mm²/s, a kinematic viscosity at 100° C. of 3.5 mm²/s or more and less than 6.0 mm²/s, a viscosity index of 95 or more, a 5% mass loss temperature of 250° C. or more, and a pour point of −40° C. or less, and a fluid dynamic bearing lubricating oil base oil having a kinematic viscosity at 40° C. of 17 mm²/s or more and less than 33 mm²/s, a kinematic viscosity at 100° C. of 4.0 mm²/s or more and less than 5.0 mm²/s, a viscosity index of 95 or more, a 5% mass loss temperature of 250° C. or more, and a pour point of −40° C. or less are preferable, and in particular, a fluid dynamic bearing lubricating oil base oil having a kinematic viscosity at 40° C. of 20 mm²/s or more and less than 30 mm²/s, a kinematic viscosity at 100° C. of 4.0 mm²/s or more and less than 5.0 mm²/s, a viscosity index of 95 or more, a 5% mass loss temperature of 250° C. or more, and a pour point of −40° C. or less is preferable.

The fluid dynamic bearing lubricating oil base oil of the present disclosure is suitably used as a fluid dynamic bearing lubricating oil base oil because it has excellent low temperature fluidity, a high viscosity index, and good heat resistance (evaporation resistance). Furthermore, the fluid dynamic bearing lubricating oil base oil is more suitably used as a fluid dynamic bearing oil base oil for a fan motor.

The fluid dynamic bearing lubricating oil base oil may contain a base oil (combined base oil) other than the isophthalic acid diester compound represented by the general formula (1). Examples of the base oil include base oils such as mineral oil (hydrocarbon oil obtained by refining petroleum), poly-α-olefin, polybutene, alkylbenzene, alkylnaphthalene, alicyclic hydrocarbon oil, animal and vegetable oil, organic acid ester (excluding the isophthalic acid diester compound according to the present invention), polyalkylene glycol, polyvinyl ether, polyphenyl ether, alkylphenyl ether, and silicone oil. At least one of these base oils can be appropriately used in combination.

Examples of the mineral oil include solvent-refined mineral oil, hydrogenated refined mineral oil, and wax isomerized oil, and those having a kinematic viscosity at 100° C. of 1 to 25 mm²/s, preferably 2 to 20 mm²/s are usually used.

Examples of the poly-α-olefin include polymers or copolymers of an α-olefin having 2 to 16 carbon atoms (for example, ethylene, propylene, 1-butene, 1-hexene, 1-octene, 1-decene, 1-dodecene, 1-tetradecene, 1-hexadecene, and the like), and poly-α-olefin having a kinematic viscosity at 100° C. of 1 to 25 mm²/s and a viscosity index of 100 or more. Particularly, poly-α-olefin having a kinematic viscosity at 100° C. of 2 to 20 mm²/s and a viscosity index of 120 or more is preferable.

Examples of the polybutene include polybutenes obtained by polymerizing isobutylene and polybutenes obtained by copolymerizing isobutylene with normal butylene, and polybutenes generally having a kinematic viscosity at 100° C. in a wide range of 2 to 30 mm²/s can be mentioned.

Examples of the alkylbenzene include benzene substituted with a linear or branched alkyl group having 1 to 40 carbon atoms, and examples thereof include monoalkylbenzene, dialkylbenzene, trialkylbenzene, and tetraalkylbenzene having a molecular weight of 200 to 450.

Examples of the alkyl naphthalene include naphthalene substituted with a linear or branched alkyl group having 1 to 30 carbon atoms, and, for example, monoalkyl naphthalene and dialkyl naphthalene are mentioned.

Examples of the alicyclic hydrocarbon oil include naphthenic hydrocarbon oils, and alicyclic hydrocarbon oils having a kinematic viscosity at 100° C. in a wide range of 1 to 40 mm²/s are generally mentioned.

Examples of the animal and vegetable oils include beef tallow, lard, palm oil, coconut oil, rapeseed oil, castor oil, and sunflower oil.

Examples of the organic acid ester include fatty acid monoesters, aliphatic dibasic acid diesters, polyol esters, and other esters.

Examples of the fatty acid monoester include an ester compound of an aliphatic linear or branched monocarboxylic acid having 5 to 22 carbon atoms and a linear or branched saturated or unsaturated aliphatic alcohol having 3 to 22 carbon atoms.

Examples of the aliphatic dibasic acid diester include diesters of an aliphatic dibasic acid such as oxalic acid, malonic acid, succinic acid, glutaric acid, adipic acid, pimelic acid, suberic acid, azelaic acid, sebacic acid, 1,9-nonamethylene dicarboxylic acid, or 1,10-decamethylene dicarboxylic acid or an anhydride thereof and a linear or branched saturated or unsaturated aliphatic alcohol having 3 to 22 carbon atoms.

As the polyol ester, for example, it is possible to use polyols with neopentyl structure such as neopentyl glycol, 2,2-diethylpropanediol, 2-butyl-2-ethylpropanediol, trimethylolethane, trimethylolpropane, pentaerythritol, ditrimethylolpropane, and dipentaerythritol, and full esters of polyols with non-neopentyl structure, such as 1,3-propanediol, 1,4-butanediol, 1,5-pentanediol, 1,6-hexanediol, 1,7-heptanediol, 1,8-octanediol, 1,9-nonanediol, 1,10-decanediol, 1,2-propanediol, 2-methyl-1,3-propanediol, 1,3-butanediol, 2-methyl-1,4-butanediol, 1,4-pentanediol, 2-methyl-1,5-pentanediol, 3-methyl-1,5-pentanediol, 1,5-hexanediol, 2-methyl-1,6-hexanediol, 3-methyl-1,6-hexanediol, 1,6-heptanediol, 2-methyl-1,7-heptanediol, 3-methyl-1,7-heptanediol, 4-methyl-1,7-heptanediol, 1,7-octanediol, 2-methyl-1,8-octanediol, 3-methyl-1,8-octanediol, 4-methyl-1,8-octanediol, 1,8-nonanediol, 2-methyl-1,9-nonanediol, 3-methyl-1,9-nonanediol, 4-methyl-1,9-nonanediol, 5-methyl-1,9-nonanediol, 2-ethyl-1,3-hexanediol, glycerin, polyglycerol, and sorbitol, and a linear and/or branched saturated or unsaturated aliphatic monocarboxylic acid having 3 to 22 carbon atoms.

Examples of other esters include polymerized fatty acids such as aromatic dicarboxylic acid esters (excluding isophthalic acid diester compounds according to the present disclosure), aromatic polycarboxylic acid esters, dimer acids, and hydrogenated dimer acids, and ester compounds of hydroxy fatty acids such as condensed castor oil fatty acids and hydrogenated condensed castor oil fatty acids with linear or branched saturated or unsaturated aliphatic alcohols having 3 to 22 carbon atoms.

Examples of the polyalkylene glycol include ring-opened polymers of an alcohol and a linear or branched alkylene oxide having 2 to 4 carbon atoms. Examples of alkylene oxides include ethylene oxide, propylene oxide, and butylene oxide, and it is possible to use polymers using one of these, or copolymers using a mixture of two or more of these. It is also possible to use such compounds wherein the hydroxy group(s) at one or both ends are etherified or esterified. The kinematic viscosity of the polymer is 5 to 50 mm²/s (40° C.), and preferably 10 to 40 mm²/s (40° C.).

Polyvinyl ethers are compounds obtained by polymerizing a vinyl ether monomer, and examples of monomers include methyl vinyl ether, ethyl vinyl ether, isopropyl vinyl ether, n-butyl vinyl ether, isobutyl vinyl ether, sec-butyl vinyl ether, tert-butyl vinyl ether, n-pentyl vinyl ether, n-hexyl vinyl ether, 2-methoxyethyl vinyl ether, and 2-ethoxyethyl vinyl ether. The kinematic viscosity of the polymer is 5 to 50 mm²/s (40° C.), and preferably 10 to 40 mm²/s (40° C.)

Examples of polyphenyl ethers include compounds having a structure where the meta positions of two or more aromatic rings are connected by ether linkages or thioether linkages, specifically, for example, bis(m-phenoxyphenyl)ether, m-bis(m-phenoxyphenoxy)benzene, and thioethers in which one or two or more oxygen atoms thereof are replaced by sulfur atoms.

Examples of alkylphenyl ethers include compounds in which a polyphenyl ether is substituted with a linear or branched alkyl group having 6 to 18 carbon atoms; in particular, alkyldiphenyl ethers substituted with one or more alkyl groups are preferable.

Examples of the silicone oil include modified silicones such as long-chain alkyl silicones and fluorosilicones, in addition to dimethyl silicone and methyl phenyl silicone.

The content of the combined base oil in the fluid dynamic bearing lubricating oil base oil is recommended to be 10% by mass or less, and is more preferably 5% by mass or less in order to improve a balance of physical properties. The fluid dynamic bearing lubricating oil base oil is particularly preferably composed only of the compound represented by the general formula (1).

The fluid dynamic bearing lubricating oil of the present disclosure includes the fluid dynamic bearing lubricating oil base oil. In order to improve the performance of the fluid dynamic bearing lubricating oil base oil, an additive (for example, an antioxidant or the like) can be blended in the fluid dynamic bearing lubricating oil in addition to the fluid dynamic bearing lubricating oil base oil.

Examples of the antioxidant include a phenol-based antioxidant, an amine-based antioxidant, and a sulfur-based antioxidant. Among them, the phenol-based antioxidant and the amine-based antioxidant are recommended.

As the phenol-based antioxidant, a known one used in this field can be used without particular limitation. Among these phenol-based antioxidants, those having a total carbon number of preferably 6 to 100 and more preferably 20 to 80 are recommended.

Specific examples thereof include 2,6-di-tert-butylphenol, 2,6-di-tert-butyl-p-cresol, 4,4′-methylenebis(2,6-di-tert-butylphenol), 4,4′-butylidenebis (3-methyl-6-tert-butylphenol), 2,2′-methylenebis(4-ethyl-6-tert-butylphenol), 2,2′-methylenebis(4-methyl-6-tert-butylphenol), 4,4′-isopropylidenebisphenol, 2,4-dimethyl-6-tert-butylphenol, tetrakis[methylene-3-(3,5-di-tert-butyl-4-hydroxyphenyl)propionate]methane, 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, 2,2′-dihydroxy-3,3′-di(α-methylcyclohexyl)-5,5′-dimethyl-diphenylmethane, 2,2′-isobutylidenebis (4,6-dimethylphenol), 2,6-bis(2′-hydroxy-3′-tert-butyl-5′-methylbenzyl)-4-methylphenol, 1,1′-bis(4-hydroxyphenyl)cyclohexane, 2,5-di-tert-amylhydroquinone, 2,5-di-tert-butylhydroquinone, 1,4-dihydroxyanthraquinone, 3-tert-butyl-4-hydroxyanisole, 2-tert-butyl-4-hydroxyanisole, 2,4-dibenzoylresorcinol, 4-tert-butylcatechol, 2,6-di-tert-butyl-4-ethylphenol, 2-hydroxy-4-methoxybenzophenone, 2,4-dihydroxybenzophenone, 2,2′-dihydroxy-4-methoxybenzophenone, 2,4,5-trihydroxybenzophenone, α-tocopherol, bis[2-(2-hydroxy-5-methyl-3-tert-butylbenzyl)-4-methyl-6-tert-butylphenyl]terephthalate, triethyleneglycol-bis[3-(3-tert-butyl-5-methyl-4-hydroxyphenyl)propionate], and 1,6-hexanediol-bis[3-(3,5-di-tert-butyl-4-hydroxyphenyl)propionate]. Among them, in particular, 2,6-di-tert-butylphenol, 2,6-di-tert-butyl-p-cresol, 4,4′-methylenebis(2,6-di-tert-butylphenol), 4,4′-butylidenebis (3-methyl-6-tert-butylphenol), 2,2′-methylenebis(4-ethyl-6-tert-butylphenol), 2,2′-methylenebis(4-methyl-6-tert-butylphenol), 4,4′-isopropylidenebisphenol, 2,4-dimethyl-6-tert-butylphenol, tetrakis[methylene-3-(3,5-di-tert-butyl-4-hydroxyphenyl)propionate]methane, 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, 2,6-di-tert-butyl-4-ethylphenol, bis[2-(2-hydroxy-5-methyl-3-tert-butylbenzyl)-4-methyl-6-tert-butylphenyl]terephthalate, triethyleneglycol-bis[3-(3-tert-butyl-5-methyl-4-hydroxyphenyl)propionate], and 1,6-hexanediol-bis[3-(3,5-di-tert-butyl-4-hydroxyphenyl)propionate] are preferable. In addition, 2,6-di-tert-butyl-p-cresol, 4,4′-methylenebis(2,6-di-tert-butylphenol) and 2,6-di-tert-butyl-4-ethylphenol are most preferable.

The phenol-based antioxidant can be used alone or in combination of two or more kinds as appropriate, and the addition amount thereof is usually 0.01 to 5 parts by mass and preferably 0.1 to 2 parts by mass with respect to 100 parts by mass of the fluid dynamic bearing lubricating oil base oil.

As the amine-based antioxidant, a known one used in this field can be used without particular limitation. Among these amine-based antioxidants, those having a total carbon number of preferably 6 to 60 and more preferably 20 to 40 are recommended.

Specific examples thereof include monoalkyldiphenylamines such as diphenylamines, monobutyl diphenylamines, monopentyl diphenylamines, monohexyl diphenylamines, monoheptyl diphenylamines, and monooctyl diphenylamines, in particular, di(alkylphenyl)amines such as mono(C4-C9 alkyl)diphenylamines (i.e., diphenylamines in which one of the two benzene rings is mono-substituted with an alkyl group, in particular, a C4-C9 alkyl group), dibutyldiphenylamine, dipentyldiphenylamine, dihexyldiphenylamine, diheptyldiphenylamine, dioctyldiphenylamine, and dinonyldiphenylamine, in particular, di(C4-C9 alkylphenyl)amines (i.e., diphenylamines in which each of the two benzene rings of the diphenylamine is mono-substituted with an alkyl group, in particular, a C4-C9 alkyl group, and the two alkyl groups are identical), di(mono C4-C9 alkylphenyl)amines in which the alkyl group on one of the benzene rings is different from the alkyl group on the other of the benzene rings, di(di-C4-C9 alkylphenyl)amines in which at least one of the four alkyl groups on the two benzene rings is different from the rest of the alkyl groups; naphthylamines such as N-phenyl-1-naphthylamine, N-phenyl-2-naphthylamine, 4-octylphenyl-1-naphthylamine, and 4-octylphenyl-2-naphthylamine; phenylenediamines such as p-phenylenediamine, N-phenyl-N′-isopropyl-p-phenylenediamine, and N-phenyl-N′-(1,3-dimethylbutyl)-p-phenylenediamine. Among these, in particular, dioctyldiphenylamine, dinonyldiphenylamine, and N-phenyl-1-naphthylamine are preferable.

In the present specification and claims, examples of the alkyl of the additive include a linear or branched alkyl having 1 to 20 carbon atoms, and preferably a linear or branched alkyl having 1 to 12 carbon atoms are mentioned. In the case of having a plurality of alkyls in the same molecule, the plurality of alkyls may be the same or different. In the case of having a plurality of alkyls having the same number of carbon atoms in the same molecule, the plurality of alkyls may be linear or branched.

The amine-based antioxidant can be used alone or in combination of two or more kinds as appropriate, and the addition amount thereof is usually 0.01 to 5 parts by mass and preferably 0.1 to 2 parts by mass with respect to 100 parts by mass of the fluid dynamic bearing lubricating oil base oil.

When the phenol-based antioxidant and the amine-based antioxidant are combined, the total addition amount thereof is usually 0.01 to 5 parts by mass and preferably 0.1 to 2 parts by mass with respect to 100 parts by mass of the fluid dynamic bearing lubricating oil base oil. A ratio (mass ratio) of the phenol-based antioxidant to the amine-based antioxidant is not particularly limited, and can be appropriately selected from a wide range. Preferably, a range in which the mass ratio of the phenol-based antioxidant (I) to the amine-based antioxidant (II) is (I):(II)=1:0.05 to 20 is recommended, and more preferably, a range in which the mass ratio is 1:0.2 to 5 is recommended.

Examples of a preferable combination of the phenol-based antioxidant and the amine-based antioxidant include a combination of one or two or more selected from the group consisting of 2,6-di-tert-butyl-p-cresol, 4,4′-methylenebis (2,6-di-tert-butylphenol), and 2,6-di-tert-butyl-4-ethylphenol and one or two or more selected from the group consisting of dioctyldiphenylamine, dinonyldiphenylamine, and N-phenyl-1-naphthylamine.

Specifically, the following combinations are preferable. A combination of 2,6-di-tert-butyl-p-cresol and dioctyldiphenylamine, a combination of 2,6-di-tert-butyl-p-cresol and dinonyldiphenylamine, a combination of 2,6-di-tert-butyl-p-cresol and N-phenyl-1-naphthylamine, a combination of 4,4′-methylenebis (2,6-di-tert-butylphenol) and dioctyldiphenylamine, a combination of 4,4′-methylenebis (2,6-di-tert-butylphenol) and dinonyldiphenylamine, a combination of 4,4′-methylenebis (2,6-di-tert-butylphenol) and N-phenyl-1-naphthylamine, a combination of 2,6-di-tert-butyl-4-ethylphenol and dioctyldiphenylamine, a combination of 2,6-di-tert-butyl-4-ethylphenol and dinonyldiphenylamine, a combination of 2,6-di-tert-butyl-4-ethylphenol and N-phenyl-1-naphthylamine, and the like are mentioned. Among these combinations, as a more effective combination in terms of excellent heat resistance, a combination of 4,4′-methylenebis (2,6-di-tert-butylphenol) and dioctyldiphenylamine, a combination of 4,4′-methylenebis (2,6-di-tert-butylphenol) and dinonyldiphenylamine, a combination of 4,4′-methylenebis (2,6-di-tert-butylphenol) and N-phenyl-1-naphthylamine, and the like are recommended.

By blending the above-described antioxidant in the fluid dynamic bearing lubricating oil base oil, decomposition and the like of the fluid dynamic bearing lubricating oil base oil in the presence of air can be suppressed, so that the heat resistance of the fluid dynamic bearing lubricating oil is improved.

In order to further improve the performance of the fluid dynamic bearing lubricating oil, at least one type of additives such as a metal cleaner, an ashless dispersant, an oiliness agent, an antiwear agent, an extreme-pressure agent, a metal deactivator, a rust inhibitor, a viscosity index improver, a pour point depressant, and a hydrolysis inhibitor can be appropriately blended. The blending amounts thereof are not particularly limited as long as the effects of the present disclosure are exhibited, and specific examples thereof are shown below.

As the metal cleaners, metal sulfonates such as Ca-petroleum sulfonates, over based Ca-petroleum sulfonates, Ca-alkylbenzene sulfonates, over based Ca-alkylbenzene sulfonates, Ba-alkylbenzene sulfonates, over based Ba-alkylbenzene sulfonates, Mg-alkylbenzene sulfonates, over based Mg-alkylbenzene sulfonates, Na-alkylbenzene sulfonates, over based Na-alkylbenzene sulfonates, Ca-alkylnaphthalene sulfonates, and over based Ca-alkylnaphthalene sulfonates; metal phenates such as Ca-phenate, over based Ca-phenate, Ba-phenate, and over based Ba-phenate; metal salicylates such as Ca-salicylate and over based Ca-salicylate; metal phosphonates such as Ca-phosphonate, over based Ca-phosphonate, Ba-phosphonate, and over based Ba-phosphonate; over based Ca-carboxylates; and the like can be used. When these metal cleaners are used, the metal cleaner can be usually added in an amount of 1 to 10 parts by mass, preferably 2 to 7 parts by mass, based on 100 parts by mass of the fluid dynamic bearing lubricating oil base oil.

Examples of ashless dispersants include polyalkenyl succinimide, polyalkenyl succinic acid amide, polyalkenyl benzylamine, and polyalkenyl succinic acid ester. These ashless dispersants may be used alone or in combination, and when the ashless dispersant is used, the ashless dispersant can be usually added in an amount of 1 to 10 parts by mass, preferably 2 to 7 parts by mass, based on 100 parts by mass of the fluid dynamic bearing lubricating oil base oil.

Examples of oiliness agents include saturated or unsaturated aliphatic monocarboxylic acids such as stearic acid and oleic acid; polymerized fatty acids such as dimer acid and hydrogenated dimer acid; hydroxyfatty acids such as ricinoleic acid and 12-hydroxystearic acid; saturated or unsaturated aliphatic monoalcohols such as lauryl alcohol and oleyl alcohol; saturated or unsaturated aliphatic monoamines such as stearyl amine and oleyl amine; saturated or unsaturated aliphatic monocarboxylic acid amides such as lauramide and oleamide; glycerin ethers such as batyl alcohol, chimyl alcohol, and selachyl alcohol; alkyl or alkenyl polyglyceryl ethers such as lauryl polyglycerol ether and oleyl polyglyceryl ether; and poly(alkylene oxide) adducts of alkyl or alkenylamine such as di(2-ethylhexyl)monoethanolamine and diisotridecyl monoethanolamine. These oiliness agents may be used alone or in combination, and when the oiliness agent is used, the oiliness agent can be usually added in an amount of 0.01 to 5 parts by mass, preferably 0.1 to 3 parts by mass, based on 100 parts by mass of the fluid dynamic bearing lubricating oil base oil.

Examples of antiwear agents and extreme-pressure agents include phosphorus-based compounds such as phosphoric acid esters such as tricresyl phosphate, cresyldiphenyl phosphate, alkylphenyl phosphates, tributyl phosphate, and dibutyl phosphate, phosphorus acid esters such as tributyl phosphite, dibutyl phosphite, and triisopropyl phosphite, as well as amine salts thereof; sulfur-based compounds such as sulfurized fatty acids such as sulfurized oils and fats and sulfurized oleic acid, di-benzyl disulfide, sulfurized olefins, and dialkyl disulfides; and organometallic compounds such as Zn-dialkyldithio phosphates, Mo-dialkyldithio phosphates, and Mo-dialkyldithio carbamates. These antiwear agents may be used alone or in combination, and when the antiwear agent is used, the antiwear agent can be usually added in an amount of 0.01 to 10 parts by mass, preferably 0.1 to 5 parts by mass, based on 100 parts by mass of the fluid dynamic bearing lubricating oil base oil.

Examples of metal deactivators include benzotriazole-based compounds, thiadiazole-based compounds, gallic acid ester-based compounds. These metal deactivators may be used alone or in combination, and when the metal deactivator is used, themetal deactivator can be usually added in an amount of 0.01 to 0.4 parts by mass, preferably 0.01 to 0.2 parts by mass, based on 100 parts by mass of the fluid dynamic bearing lubricating oil base oil.

Examples of rust inhibitors include alkyl or alkenyl succinic acid derivatives such as dodecenylsuccinic acid half esters, octadecenylsuccinic anhydride, and dodecenylsuccinic acid amide; partial esters of polyhydric alcohols such as sorbitan monooleate, glycerol monooleate, and pentaerythritol monooleate; metal sulfonates such as Ca-petroleum sulfonate, Ca-alkylbenzene sulfonates, Ba-alkylbenzene sulfonates, Mg-alkylbenzene sulfonates, Na-alkylbenzene sulfonates, Zn-alkylbenzene sulfonates, and Ca-alkylnaphthalene sulfonates; amines such as rosin amine and N-oleyl sarcosine; and dialkyl phosphite amine salts. These rust inhibitors may be used alone or in combination, and when the rust inhibitor is used, the rust inhibitor can be usually added in an amount of 0.01 to 5 parts by mass, preferably 0.05 to 2 parts by mass, based on 100 parts by mass of the fluid dynamic bearing lubricating oil base oil.

Examples of viscosity index improvers include olefin copolymers such as polyalkylmethacrylates, polyalkylstyrenes, polybutenes, ethylene-propylene copolymers, styrene-diene copolymers, and styrene-maleic anhydride ester copolymers. These viscosity index improvers may be used alone or in combination, and when the viscosity index improver is used, the viscosity index improver can be usually added in an amount of 0.1 to 15 parts by mass, preferably 0.5 to 7 parts by mass, based on 100 parts by mass of the fluid dynamic bearing lubricating oil base oil.

Examples of pour point depressants include condensates of chlorinated paraffin and alkylnaphthalene, condensates of chlorinated paraffin and phenol, and polyalkylmethacrylates, polyalkylstyrenes, polybutenes, and the like, which are the viscosity index improvers described above. These pour point depressants may be used alone or in combination, and when the pour point depressant is used, the pour point depressant can be usually added in an amount of 0.01 to 5 parts by mass, preferably 0.1 to 3 parts by mass, based on 100 parts by mass of the fluid dynamic bearing lubricating oil base oil.

Examples of usable hydrolysis inhibitors include epoxy compounds such as alkyl glycidyl ethers, alkyl glycidyl esters, alkylene glycol glycidyl ethers, alicyclic epoxides, and phenyl glycidyl ether, and carbodiimide compounds such as di-tert-butylcarbodiimide and 1,3-di-p-tolylcarbodiimide; and the hydrolysis inhibitor can be usually added in an amount of 0.05 to 2 parts by mass based on 100 parts by mass of the fluid dynamic bearing lubricating oil base oil.

The present disclosure will be described below in detail with reference to Examples; however, the present disclosure is not limited to these Examples. The physical properties and chemical properties of the fluid dynamic bearing lubricating oil base oil and the fluid dynamic bearing lubricating oil in each Example were evaluated by the following methods. For the compounds that are not detailed here, reagents were used.

<Compound>

Raw Materials
Dimethyl isophthalate: produced by Tokyo Chemical Industry
1-Pentanol: produced by Tokyo Chemical Industry
1-Hexanol: produced by Tokyo Chemical Industry
1-Heptanol: produced by Tokyo Chemical Industry
1-Octanol: produced by Tokyo Chemical Industry
1-Nonanol: produced by Tokyo Chemical Industry
1-Decanol: produced by Tokyo Chemical Industry
1-Dodecanol: produced by Tokyo Chemical Industry
2-Ethyl-1-hexanol: Product name “Octanol” produced by KH Neochem Co., Ltd.
3,5,5-Trimethyl-1-hexanol: Product name “Nonanol” produced by KH Neochem Co., Ltd.
Di(2-ethylhexyl) sebacate: Product name “SANSO CIZER DOS” produced by New Japan Chemical Co., Ltd.

Catalyst
Tetra-n-butoxytitanium: Product name “B-1” produced by Nippon Soda Co., Ltd.

Antioxidants
Amine-based antioxidant

Dioctyl (including linear and branched) diphenylamine: Product name “ANTAGE LDA” produced by Kawaguchi Chemical Industry Co., LTD.
Phenol-based antioxidant

4,4′-Methylenebis (2,6-di-tert-butylphenol) (produced by Tokyo Chemical Industry) hereinafter abbreviated as “MBDBP”.

(a) Acid Value

The acid value was measured in accordance with JIS-K-2501 (2003). The limit of detection is 0.01 KOHmg/g.

(b) Kinematic Viscosity

The kinematic viscosity at 40° C. and 100° C. was measured in accordance with JIS-K-2283 (2000).

<Evaluation of Kinematic Viscosity at 40° C.>

A: 20 mm²/s or more and less than 30 mm²/s

B: 17 mm²/s or more and less than 20 mm²/s, or 30 mm²/s or more and less than 33 mm²/s

C: less than 17 mm²/s or 33 mm²/s or more

<Evaluation of Kinematic Viscosity at 100° C.>

A: 4.0 mm²/s or more and less than 5.0 mm²/s

B: 3.5 mm²/s or more and less than 4.0 mm²/s, or 5.0 mm²/s or more and less than 6.0 mm²/s

C: less than 3.5 mm²/s or 6.0 mm²/s or more

(c) Viscosity Index

The viscosity index was calculated in accordance with JIS-K-2283 (2000).

<Evaluation of Viscosity Index>

A: 95 or more

B: 85 or more and less than 95

C: Less than 85

(d) Low Temperature Fluidity Test (Pour Point)

The pour point was measured in accordance with JIS-K-2269 (1987).

<Evaluation of Low Temperature Fluidity Test (Pour Point)>

A: −40° C. or less

B: more than −40° C. and −25° C. or less

C: more than −25° C.

(e) Evaporation Resistance

About 10 mg of lubricant oil base oil for a fluid bearing was accurately weighed (to the third decimal place), and placed in a TG-DTA device (manufactured by SII NanoTechnology Inc., device name: EXSTAR 6000 series, TG/DTA 6200). The temperature at which the mass was reduced by 5% from the initial mass (5% mass loss temperature) under the following measurement conditions was used as an index of evaporation resistance.

[Measurement Conditions]

Temperature increase rate: 10° C./min

Circulated air amount: 50 ml/min

Measurement start temperature: 50° C.

<Evaluation of Evaporation Resistance>

A: 250° C. or more

B: 240° C. or more and less than 250° C.

C: less than 240° C.

(f) Evaluation of Fluid Dynamic Bearing Lubricating Oil Base Oil

As the evaluation of the fluid dynamic bearing lubricating oil base oil, in the results of evaluation of kinematic viscosity and viscosity index, evaluation of low temperature fluidity, and evaluation of evaporation resistance, if 1 or more results are rated C, the fluid dynamic bearing lubricating oil base oil is evaluated as unsuitable; if 2 or less results are rated B (being rated A in other evaluations), the fluid dynamic bearing lubricating oil base oil is evaluated as good; and if 1 or less results are rated B (being rated A in other evaluations), the fluid dynamic bearing lubricating oil base oil is evaluated as particularly good.

(g) Measurement Conditions of Gas Chromatography (GC)

Instrument: GC-2010 manufactured by Shimadzu Corporation

Column: TC-5, 30 m×0.25 mm×0.25 μm (produced by GL Sciences Inc.)

Column temperature: 60° C.—temperature increase rate: 10° C./min—300° C. (holding time 7 min) Injection temperature/detector temperature: 305° C./305° C. Split ratio: 25:1 Column flow rate: 1.08 ml/min Purge flow rate: 3.0 ml/min

Detector: FID

Carrier gas: Helium

Gas linear velocity: 27.4 cm/sec

Sample: 1% by mass acetone solution

Injection amount: 1 μl

### Example 1

520.6 g (4.48 mol) of 1-heptanol, 310.7 g (1.6 mol) of dimethyl isophthalate, and tetra-n-butoxytitanium (0.1% by mass relative to the total amount of raw materials) as a catalyst were placed in a 1-L four-necked flask equipped with a stirrer, a thermometer, and a water fraction receiver with a cooling pipe. After purging with nitrogen, the mixture was gradually heated to 200° C. An esterification reaction was performed while removing distilled methanol with reference to the theoretical methanol amount (102.4 g). After confirming by gas chromatography (GC) that a peak corresponding to isophthalic acid methyl ester disappeared, 1-heptanol as a remaining raw material was removed by distillation to obtain a crude esterified product. Next, after neutralization with 5 equivalents of a caustic soda aqueous solution relative to the acid value of the obtained crude esterified product, water washing was repeated until the washing water was neutral. In addition, after the obtained crude esterified product was subjected to adsorption treatment with activated carbon, the activated carbon was removed by filtration, thereby obtaining 464.1 g of di-n-heptyl isophthalate. The obtained di-n-heptyl isophthalate was subjected to gas chromatography (GC) analysis to find that the purity was 99.0 GC area % and the acid value was less than 0.01 KOHmg/g. Using the compound as the fluid dynamic bearing lubricating oil base oil (A), measurement of kinematic viscosity and viscosity index, a low temperature fluidity test (pour point), and an evaporation resistance test were performed. The results are shown in Table 1.

### Example 2

506.2 g of di-n-octyl isophthalate with a purity of 99.4 GC area % and an acid value of less than 0.01 KOHmg/g was obtained by the same method as in Example 1 except that 583.4 g (4.48 mol) of 1-octanol was used instead of 1-heptanol. Using the compound as the fluid dynamic bearing lubricating oil base oil (B), measurement of kinematic viscosity and viscosity index, a low temperature fluidity test (pour point), and an evaporation resistance test were performed. The results are shown in Table 1.

### Example 3

535.9 g of di-n-nonyl isophthalate with a purity of 99.3 GC area % and an acid value of less than 0.01 KOHmg/g was obtained by the same method as in Example 1 except that 646.2 g (4.48 mol) of 1-nonanol was used instead of 1-heptanol. Using the compound as the fluid dynamic bearing lubricating oil base oil (C), measurement of kinematic viscosity and viscosity index, a low temperature fluidity test (pour point), and an evaporation resistance test were performed. The results are shown in Table 1.

### Example 4

586.1 g of di-n-decyl isophthalate with a purity of 99.4 GC area % and an acid value of less than 0.01 KOHmg/g was obtained by the same method as in Example 1 except that 709.1 g (4.48 mol) of 1-decanol was used instead of 1-heptanol. Using the compound as the fluid dynamic bearing lubricating oil base oil (D), measurement of kinematic viscosity and viscosity index, a low temperature fluidity test (pour point), and an evaporation resistance test were performed. The results are shown in Table 1.

### Example 5

By the same method as in Example 1 except that 228.9 g (2.24 mol) of 1-hexanol and 354.5 g (2.24 mol) of 1-decanol were used instead of 1-heptanol, 464.1 g of an isophthalic acid diester mixture was obtained which was present in a ratio of 25.3 GC area % for di-n-hexyl isophthalate, 22.9 GC area % for di-n-decyl isophthalate, and 50.9 GC area % for isophthalic acid (n-decyl) (n-hexyl) and which was obtained by an esterification reaction of isophthalic acid having an acid value of less than 0.01 KOHmg/g with n-hexanol and n-decanol. Using the compound as the fluid dynamic bearing lubricating oil base oil (E), measurement of kinematic viscosity and viscosity index, a low temperature fluidity test (pour point), and an evaporation resistance test were performed. The results are shown in Table 1.

### Example 6

By the same method as in Example 1 except that 291.7 g (2.24 mol) of 1-octanol and 354.5 g (2.24 mol) of 1-decanol were used instead of 1-heptanol, 529.2 g of an isophthalic acid diester mixture was obtained which was present in a ratio of 15.6 GC area % for di-n-octyl isophthalate, 35.5 GC area % for di-n-decyl isophthalate, and 48.6 GC area % for isophthalic acid (n-decyl) (n-octyl) and which was obtained by an esterification reaction of isophthalic acid having an acid value of less than 0.01 KOHmg/g with n-octanol and n-decanol. Using the compound as the fluid dynamic bearing lubricating oil base oil (F), measurement of kinematic viscosity and viscosity index, a low temperature fluidity test (pour point), and an evaporation resistance test were performed. The results are shown in Table 1.

TABLE 1

| | | | | | | Heat resistance |
|---|---|---|---|---|---|---|
| | Fluid dynamic | | | | | temperature of |
| | bearing | Kinematic viscosity [mm²/s] | | Viscosity | Pour point | reduction by |
| | lubricating | 40° C. | 100° C. | index | [° C.] | 5 mass % [° C.] |
| | oil base oil | (Evaluation) | (Evaluation) | (evaluation) | (evaluation) | (evaluation) |
| Example 1 | Ester (A) | 20.6 | 4.01 | 85 | −47.5 | 251 |
| | | (A) | (A) | (B) | (A) | (A) |
| Example 2 | Ester (B) | 22.1 | 4.29 | 98 | −40.0 | 257 |
| | | (A) | (A) | (A) | (A) | (A) |
| Example 3 | Ester (C) | 25.8 | 4.85 | 110 | −25.0 | 266 |
| | | (A) | (A) | (A) | (B) | (A) |
| Example 4 | Ester (D) | 30.0 | 5.47 | 119 | −27.5 | 270 |
| | | (B) | (A) | (A) | (B) | (A) |
| Example 5 | Ester (E) | 21.4 | 4.23 | 101 | −52.5 | 248 |
| | | (A) | (A) | (A) | (A) | (B) |
| Example 6 | Ester (F) | 26.4 | 4.97 | 113 | −45.0 | 269 |
| | | (A) | (A) | (A) | (A) | (A) |

### Comparative Example 1

Using di(2-ethylhexyl) sebacate (DOS) as a fluid dynamic bearing lubricating oil base oil outside the present disclosure, measurement of kinematic viscosity and viscosity index, a low temperature fluidity test (pour point), and an evaporation resistance test were performed. The results are shown in Table 2.

### Comparative Example 2

367.8 g of di-n-pentyl isophthalate with a purity of 99.0 GC area % and an acid value of less than 0.01 KOHmg/g was obtained by the same method as in Example 1 except that 394.9 g (4.48 mol) of 1-pentanol was used instead of 1-heptanol. Using the compound as the fluid dynamic bearing lubricating oil base oil (a) outside the present disclosure, measurement of kinematic viscosity and viscosity index, a low temperature fluidity test (pour point), and an evaporation resistance test were performed. The results are shown in Table 2.

### Comparative Example 3

643.6 g of di-n-dodecyl isophthalate with a purity of 99.2 GC area % and an acid value of less than 0.01 KOHmg/g was obtained by the same method as in Example 1 except that the reaction vessel was changed from a 1-L four-necked flask to a 2-L four-necked flask and 834.8 g (4.48 mol) of 1-dodecanol was used instead of 1-heptanol. Using the compound as the fluid dynamic bearing lubricating oil base oil (b) outside the present disclosure, measurement of kinematic viscosity and viscosity index, a low temperature fluidity test (pour point), and an evaporation resistance test were performed. The results are shown in Table 2.

### Comparative Example 4

500.0 g of di(2-ethylhexyl) isophthalate with a purity of 99.0 GC area % and an acid value of less than 0.01 KOHmg/g was obtained by the same method as in Example 1 except that 583.4 g (4.48 mol) of 2-ethylhexanol was used instead of 1-heptanol. Using the compound as the fluid dynamic bearing lubricating oil base oil (c) outside the present disclosure, measurement of kinematic viscosity and viscosity index, a low temperature fluidity test (pour point), and an evaporation resistance test were performed. The results are shown in Table 2.

### Comparative Example 5

509.1 g of di(3,5,5-trimethylhexanol) isophthalate with a purity of 99.1 GC area % and an acid value of less than 0.01 KOHmg/g was obtained by the same method as in Example 1 except that 646.2 g (4.48 mol) of 3,5,5-trimethylhexanol was used instead of 1-heptanol. Using the compound as the fluid dynamic bearing lubricating oil base oil (d) outside the present disclosure, measurement of kinematic viscosity and viscosity index, a low temperature fluidity test (pour point), and an evaporation resistance test were performed. The results are shown in Table 2.

TABLE 2

| | | | | | | Heat resistance |
|---|---|---|---|---|---|---|
| | Fluid dynamic | | | | | temperature of |
| | bearing | Kinematic viscosity [mm²/s] | | Viscosity | Pour point | reduction by |
| | lubricating | 40° C. | 100° C. | index | [° C.] | 5 mass % [° C.] |
| | oil base oil | (Evaluation) | (Evaluation) | (evaluation) | (evaluation) | (evaluation) |
| Comparative | DOS | 11.5 | 3.21 | 153 | <−55.0 | 240 |
| Example 1 | | (C) | (C) | (A) | (A) | (B) |
| Comparative | Ester (a) | 12.7 | 2.86 | 53 | −57.5 | 220 |
| Example 2 | | (C) | (C) | (C) | (A) | (C) |
| Comparative | Ester (b) | 38.7 | 6.76 | 132 | >20.0 | 278 |
| Example 3 | | (C) | (C) | (A) | (C) | (A) |
| Comparative | Ester (c) | 30.3 | 4.54 | 27 | −55.0 | 246 |
| Example 4 | | (B) | (A) | (C) | (A) | (B) |
| Comparative | Ester (d) | 48.4 | 6.47 | 79 | −32.5 | 260 |
| Example 5 | | (C) | (C) | (C) | (B) | (A) |

### Examples 7 to 9

The fluid dynamic bearing lubricating oil of the present disclosure was prepared by adding 1 part by mass of an antioxidant to 100 parts by mass of the lubricant oil base oil for a fluid bearing of Example 2. Each of the prepared fluid dynamic bearing lubricating oils was subjected to measurement of kinematic viscosity and viscosity index, a low temperature fluidity test (pour point), and an evaporation resistance test in the same manner as the fluid dynamic bearing lubricating oil base oil. The results are shown in Table 3.

TABLE 3

| | Fluid dynamic | | | | | | Heat resistance |
|---|---|---|---|---|---|---|---|
| | bearing | | | | | | temperature of |
| | lubricating oil | Antioxidant | Kinematic viscosity [mm²/s] | | Viscosity | Pour point | reduction by |
| | base oil | [part(s) by | 40° C. | 100° C. | index | [° C.] | 5 mass % [° C.] |
| | [part(s) by mass] | mass] | (Evaluation) | (Evaluation) | (evaluation) | (evaluation) | (evaluation) |
| Example 7 | Ester (B) | ANTAGE LDA | 22.4 | 4.29 | 94 | −40.0 | 272 |
| | [100] | [1] | (A) | (A) | (B) | (A) | (A) |
| Example 8 | Ester (B) | MBDBP | 22.5 | 4.30 | 94 | 40.0 | 274 |
| | [100] | [1] | (A) | (A) | (B) | (A) | (A) |
| Example 9 | Ester (B) | ANTAGE LDA | 22.4 | 4.29 | 94 | −40.0 | 273 |
| | [100] | [0.5] | (A) | (A) | (B) | (A) | (A) |
| | | MBDBP | | | | | |
| | | [0.5] | | | | | |

Table 1 shows that the fluid dynamic bearing lubricating oil base oil of the present disclosure is within a suitable 40° C. and 100° C. kinematic viscosity range from the viewpoint of energy saving and high bearing rigidity, and is an excellent lubricating oil base oil having a high viscosity index and good low temperature fluidity and heat resistance (evaporation resistance). Table 3 shows that the fluid dynamic bearing lubricating oil of the present disclosure is within a suitable 40° C. and 100° C. kinematic viscosity range, is an excellent fluid dynamic bearing lubricating oil having a high viscosity index and good low temperature fluidity and heat resistance (evaporation resistance), and is particularly excellent as a fluid dynamic bearing lubricating oil base oil for a fan motor.

The fluid dynamic bearing lubricating oil base oil of the present disclosure is an excellent lubricating oil base oil which is within a suitable 40° C. and 100° C. kinematic viscosity range from the viewpoint of energy saving and high bearing rigidity, and is an excellent lubricating oil base oil having a high viscosity index and good low temperature fluidity and heat resistance (evaporation resistance), and thus can be suitably used as a fluid dynamic bearing lubricating oil base oil. For example, the fluid dynamic bearing lubricating oil base oil of the present disclosure can be used for HDD spindle motors using fluid dynamic bearings, particularly fan motors.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A fluid dynamic bearing lubricating oil base oil comprising an isophthalic acid diester compound represented by a general formula (1) 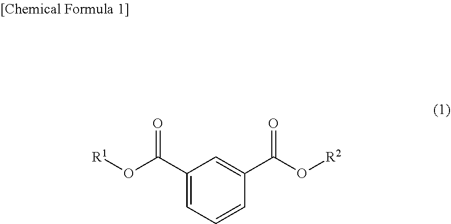
wherein R1 and R2 are the same or different and each represent a linear alkyl group having 6 to 10 carbon atoms.

2. The fluid dynamic bearing lubricating oil base oil according to claim 1, wherein a content of the isophthalic acid diester compound represented by the general formula (1) is 70% by mass or more in the fluid dynamic bearing lubricating oil base oil.

3. A fluid dynamic bearing lubricating oil base oil comprising the fluid dynamic bearing lubricating oil base oil according to claim 1, being a fluid dynamic bearing lubricating oil base oil for a fan motor.

4. A fluid dynamic bearing lubricating oil comprising the fluid dynamic bearing lubricating oil base oil according to claim 1.

5. A fluid dynamic bearing lubricating oil comprising the fluid dynamic bearing lubricating oil according to claim 4 being a fluid dynamic bearing lubricating oil for a fan motor.

6. A fluid dynamic bearing comprising the fluid dynamic bearing lubricating oil according to claim 4.

7. A motor comprising the fluid dynamic bearing according to claim 6.

8. A fun motor comprising the motor according to claim 7.
